(19) United States
(12) Patent Application Publication
(10) Pub. No.: US 2026/0215620 A1
(43) Pub. Date: Jul. 30, 2026

(54) BURNER ASSEMBLY FOR AN APPLIANCE

(71) Applicant: North Atlantic Imports, LLC, Logan, UT (US)

(72) Inventors: Gary Ellis Graham, Hyde Park, UT (US); James Clifford Bush, Providence, UT (US)

(73) Assignee: North Atlantic Imports, LLC, Logan, UT (US)

(21) Appl. No.: 19/267,325

(22) Filed: Jul. 11, 2025

Related U.S. Application Data
(60) Provisional application No. 63/670,542, filed on Jul. 12, 2024.
(60) Provisional application No. 63/749,864, filed on Jan. 27, 2025.
(60) Provisional application No. 63/769,438, filed on Mar. 10, 2025.

(51) Int. Cl. A47J 37/06; A47J 36/32; F23D 14/04; F24C 15/00

(52) U.S. Cl. CPC A47J 37/0682; A47J 36/32; F23D 14/04; F24C 15/00; F23D 2900/14064

(57) ABSTRACT

An appliance includes a chassis, a griddle body coupled to the chassis, a burner assembly coupled to the chassis, and a sensor coupled to the chassis. The burner assembly is positioned below the griddle body and is spaced away from the griddle body. The burner assembly includes a burner tube coupled to the chassis and a burner body coupled to the burner tube. The burner body has a burner body first end and a burner body second end. The burner body defines an burner aperture positioned between the burner body first end and the burner body second end. The sensor extends axially through the burner aperture such that a distal end of the sensor is positioned proximate the griddle body.

### CROSS-REFERENCE TO RELATED APPLICATIONS

This Application claims the benefit and priority to U.S. Provisional Application No. 63/670,542 filed Jul. 12, 2024, U.S. Provisional Application No. 63/749,864 filed Jan. 27, 2025, and U.S. Provisional Application No. 63/769,438 filed Mar. 10, 2025, all of which are incorporated herein by reference in their entirety and for all purposes.

### FIELD

The present disclosure relates generally to a burner assembly for a cooking appliance.

### BACKGROUND

Appliances for preparing a food product, such as a griddle (e.g., a gas griddle, an electric griddle, etc.), are used to heat the food product to a desired temperature. A griddle surface is heated (e.g., by the combustion of gas or by an electric heating element), and the food product is placed on the griddle surface in order to heat the food product.

### SUMMARY

One embodiment relates to an appliance. The appliance includes a chassis, a griddle body, a burner assembly, and a sensor. The griddle body is coupled to the chassis. The burner assembly is coupled to the chassis, positioned below the griddle body, and spaced away from the griddle body. The burner assembly includes a burner tube coupled to the chassis and a burner body coupled to the burner tube. The burner body has a burner body first end and a burner body second end. The burner body defines a burner aperture positioned between the burner body first end and the burner body second end. The sensor is coupled to the chassis and extends axially through the burner aperture, such that a distal end of the sensor is positioned proximate the griddle body.

Another embodiment relates to a system for preparing a food product. The system includes a griddle body, a burner assembly, and a sensor. The griddle body is configured to receive the food product thereon. The burner assembly is positioned below the griddle body and spaced away from the griddle body. The burner assembly includes a burner body having a burner body first end and a burner body second end. The burner body defines a burner aperture positioned between the burner body first end and the burner body second end. The sensor extends axially through the burner aperture, such that a distal end of the sensor is positioned proximate the griddle body.

Still another embodiment relates to a burner assembly for an appliance. The burner assembly includes a burner body having a burner body first end and a burner body second end. The burner body defines an aperture positioned between the burner body first end and the burner body second end. The aperture is sized to receive a portion of a sensor therethrough. The burner tube is coupled to the burner body between the aperture and the burner body first end.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a griddle, according to an example embodiment.

FIG. 2 is another perspective view of the griddle of FIG. 1, shown without a griddle body.

FIG. 3 is a perspective view of a burner assembly of the griddle of FIG. 1.

FIG. 4 is a perspective view of the burner assembly of FIG. 3, shown in a disassembled state.

FIG. 5 is a side cross-sectional view of an upper body portion of the burner assembly of FIG. 3.

FIG. 6 is a side cross-sectional view of a lower body portion of the burner assembly of FIG. 3.

FIG. 7 is a side cross-sectional view of the burner assembly of FIG. 3.

FIG. 8 is a perspective view showing a portion of the griddle of FIG. 1.

FIG. 9 is a perspective view of a sensor assembly usable with the griddle assembly of FIG. 1.

FIG. 10 is a side view of the burner assembly of FIG. 3, shown in a first configuration.

FIG. 11 is a perspective view of the burner assembly of FIG. 10.

FIG. 12 is a perspective view of the burner assembly of FIG. 3, shown in a second configuration.

FIG. 13 is a perspective view of a griddle, according to another example embodiment.

FIG. 14 is a perspective view of the griddle of FIG. 13, shown in a partially disassembled state.

FIG. 15 is a front sectional view of the griddle of FIG. 13, taken along the line A-A.

FIG. 16 is a first side sectional view of the griddle of FIG. 13, taken along the line B-B.

FIG. 17 is a second side sectional view of the griddle of FIG. 13, taken along the line C-C.

FIG. 18 is a bottom perspective view of a portion of the griddle of FIG. 13.

FIG. 19 is another bottom perspective view of a portion of the griddle of FIG. 13.

FIG. 20 is yet another bottom perspective view of a portion of the griddle of FIG. 13.

FIG. 21 is a bottom perspective view of the griddle of FIG. 13, shown in a partially disassembled state.

### DETAILED DESCRIPTION

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

Conventional cooking appliances may include temperature sensors for measuring a temperature of (or proximate) a cooking surface. The temperature sensors of these conventional cooking appliances may be directly coupled to the cooking surface. Accordingly, the cooking surface of conventional cooking appliances cannot be readily removed from the cooking appliance without decoupling the sensors from the cooking surface and/or decoupling the sensors from the cooking appliance. Additionally, the temperature sensors of conventional cooking appliances may be spaced away from heating elements of the cooking appliance. Accordingly, the temperature sensors of conventional cooking appliances may measure a temperature of the cooking surface away from the heating elements. This arrangement can result in the temperature data acquired by these temperature sensors being inaccurate or otherwise undesirable. Furthermore, because the temperature sensors are positioned away from a flame produced by the heating elements and oftentimes a distance away from the heating elements, acquired temperature measurements may not accurately convey the true temperature in a zone of the cooking surface nearest the heating elements. Additionally, the limited location options utilized by conventional cooking applications limits the number of temperature sensors, which contributes to inaccurate or otherwise undesirable temperature data acquisition.

Referring to the Figures generally, various embodiments disclosed herein relate to a burner assembly for a cooking appliance. The cooking appliance includes, for example, a frame, one or more burner assemblies coupled to the frame, a griddle body coupled to the frame, and one or more temperature sensors. The temperature sensor(s) are mounted below the burner assemblies and extend through an aperture defined within the burner assembly, towards the griddle body, such that a distal end of the temperature sensor is positioned proximate a lower surface of the griddle body, without being coupled to the griddle body. Advantageously, the griddle body can be removed from the frame, without the need to also decouple from sensors.

The cooking appliance may include multiple burner assemblies (e.g., two or more burner assemblies), and each burner assembly has a corresponding temperature sensor extending therethrough. In this way, each of the temperature sensors are positioned to acquire data regarding a temperature of the griddle body proximate the corresponding burner assembly. Said another way, each of the temperature sensors is positioned to acquire data regarding a temperature of the griddle body that corresponds to the portion of the griddle body that the burner assembly, through which the temperature sensor extends, is configured to heat. This arrangement allows the temperature sensors to acquire more accurate temperature data regarding the griddle body and provides additional location options for such temperature sensors thus permitting the use of additional temperature sensors to capture more temperature data associated with the cooking surface.

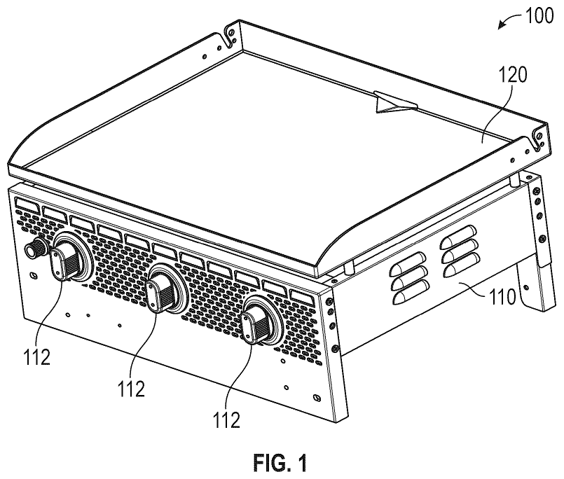

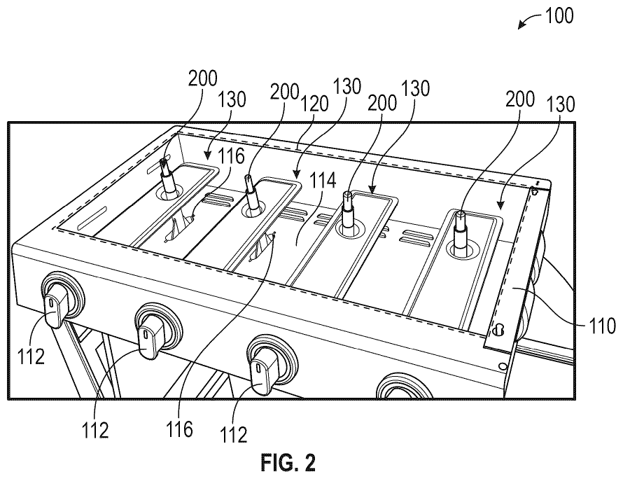

FIGS. 1 and 2 depict perspective views of a griddle 100, according to an example illustrative embodiment. As shown in FIGS. 1 and 2, an appliance or system for preparing a food product (e.g., a cooking station), shown as griddle 100, includes a chassis (e.g., a main body), shown as a frame 110; one or more heating elements, shown as burner assemblies 130 (shown in FIG. 2), coupled to the frame 110; and one or more sensors 200 (shown in FIG. 2), coupled to the frame 110. The griddle 100 also includes a food preparation portion, shown as griddle body 120 (shown in FIG. 1). The griddle 100 is shown without the griddle body 120 in FIG. 2. As shown in FIGS. 1 and 2, the griddle 100 includes one or more operator interface devices, shown as knobs 112, coupled to the frame 110, and a lower panel, shown as a plate 114 coupled to the frame 110. In some embodiments, the griddle 100 includes more or fewer components.

According to an example embodiment, the griddle 100 is a fuel-powered griddle that consumes a fuel, such as natural gas or propane, to heat the griddle body 120 via the burner assemblies 130. By way of example, a fuel line or a fuel tank (e.g., a propane tank) may be coupled to frame 110 and in fuel providing communication with the burner assemblies 130, and the fuel may be selectively routed to one or more of the burner assemblies 130, where the fuel is consumed to heat the griddle body 120. In some embodiments, the griddle 100 is a freestanding appliance, which is supported on legs or wheels. In other embodiments, the griddle 100 is a built-in appliance that is coupled to an existing structure, such as a cabinet structure, a kitchen island, and so on. In still other embodiments, the griddle 100 is a portable appliance that is positionable on a surface, such as a table, a cart, or other suitable surface. In these embodiments, the griddle 100 may include a handle for carrying or otherwise moving the griddle 100.

According to the example embodiment shown in FIGS. 1 and 2, the knobs 112 are each coupled to a flow regulation device, such as a valve (not shown). Each valve (or other flow regulation device) is configured to regulate the flow of fuel from the fuel line or the fuel tank to a corresponding burner assembly 130. The knobs 112 are repositionable between a first position (e.g., an off position) and a second position (e.g., an on position). In the first position, the knob 112 causes the corresponding valve to substantially prevent the flow of fuel to the corresponding burner assembly 130. In the second position, the knob 112 causes the corresponding valve to allow a predetermined amount of fuel to flow to the corresponding burner assembly 130. By way of example, an amount of fuel provided to the corresponding burner assembly 130 may be selected by positioning the knob 112 between the first position and the second position, inclusive. In the embodiment shown in FIG. 1, the griddle 100 includes three knobs 112. In the embodiment shown in FIG. 2, the griddle 100 includes four knobs 112. It should be understood that the griddle 100 may include more or fewer knobs 112 than as shown in FIGS. 1 and 2 (e.g., at least one knob 112).

According to the example embodiment shown in FIG. 2, the plate 114 is positioned below the burner assembly 130. More specifically, the plate 114 is spaced away from the burner assembly 130. The plate 114 defines one or more plate apertures 116. Each of the plate apertures 116 is sized to receive a corresponding component, such as a corresponding sensor 200.

In an example embodiment, an internal volume of the griddle 100 is at least partially defined between the plate 114 and the griddle body 120. The burner assemblies 130 and the sensors 200 are at least partially positioned within the internal volume of the griddle 100.

As shown in FIG. 2, the griddle 100 includes four burner assemblies 130 and four sensors 200. It should be understood that, in other embodiments, the griddle 100 may include more or fewer burner assemblies 130 and sensors 200. In any of these embodiments, the griddle 100 may include the same number of burner assemblies 130 and sensors 200 such that each burner assembly 130 has a corresponding sensor 200.

Each of the burner assemblies 130 is positioned relative to a corresponding portion or zone of the griddle body 120. By way of example, each of the burner assemblies 130 can be positioned vertically below the corresponding portion of the griddle body 120. The knobs 112 are positionable to selectively provide a desired amount of fuel to each of the burner assemblies 130, and, when the fuel is combusted at the burner assemblies 130, the corresponding portion of the griddle body 120 is heated. By way of example, a first burner assembly of the burner assemblies 130 can be positioned to heat a first portion of the griddle body 120, and a second burner assembly of the burner assemblies 130 can be positioned to heat a second portion of the griddle body 120. It should be understood that the heat produced at each of the burner assemblies 130 can indirectly heat another portion of zone of the griddle body 120 that is horizontally offset from a burner assemblies 130 (e.g., via conduction from one portion of the griddle body 120 to another and/or via convention from air between the burner assemblies 130 and the griddle body 120).

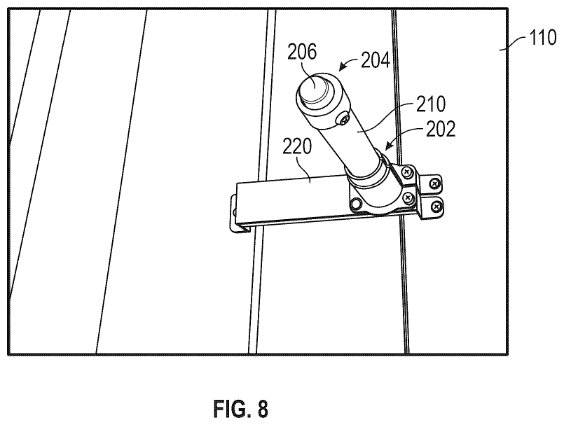

The one or more sensors 200 are temperature sensors configured to acquire data regarding a temperature of the griddle body 120. As shown in FIGS. 8 and 9, the one or more sensors 200 include a proximal end 202 and a distal end 204, opposite the proximal end 202. The proximal end 202 is positioned at or proximate the plate 114. The 204 is positioned proximate the griddle body 120 (e.g., between the burner assemblies 130 and the griddle body 120).

The one or more sensors 200 include a data acquisition component 206 positioned at or proximate the distal end of the sensors 200. The data acquisition component may include, for example, a thermocouple, a resistance temperature detector, a thermistor, an infrared sensor, a temperature sensing bulb, or other suitable data acquisition component. The one or more sensors 200 include a housing 210 extending between the proximal end 202 and the distal end 204. The data acquisition component 206 is positioned at least partially within the housing 210. Accordingly, the housing 210 is sized to receive at least a portion of the data acquisition component 206 therein. By way of example, the housing 210 may be substantially tubular in shape (e.g., a hollow cylinder). In some embodiments, at least a portion of the data acquisition component 206 extends outward from the housing 210, such that at least a portion of the data acquisition component 206 is positioned outside of the housing 210 (e.g., between the housing 210 and the griddle body 120).

In some embodiments, the housing 210 is a heat shield that is configured to thermally isolate at least a portion of the data acquisition component 206 from the exterior of the housing 210. In this way, the housing 210 mitigates indirect heating of data acquisition component 206 by nearby components, thereby allowing the data acquisition component 206 to more accurately acquire data regarding the temperature of the griddle body 120.

In the embodiment shown in FIGS. 8 and 9, the one or more sensors 200 include a biasing member, shown as a spring member 212, positioned at the proximal end 202 and within the housing 210. The spring member 212 contacts (e.g., either directly or indirectly, via one or more intermediate components) the data acquisition component 206, such that the spring member 212 biases the data acquisition component 206 in a direction towards the griddle body 120. By way of example, the spring member 212 may be at least partially compressed within the housing 210, such that the spring member 212 provides a force on the data acquisition component 206 in the direction towards the griddle body 120, such that the data acquisition component 206 is positioned proximate to or contacts the griddle body 120. In some embodiments, when the griddle body 120 contacts the data acquisition component 206, the data acquisition component 206 is forced in a direction away from the griddle body 120 (e.g., due to the weight of the griddle body 120), and the spring member 212 is further compressed within the housing 210.

In the embodiment shown in FIGS. 8 and 9, the one or more sensors 200 include a mounting member, shown as a bracket 220, positioned at the proximal end 202 of the one or more sensors 200. The bracket 220 facilitates coupling the housing 210 to another component of the griddle 100. In the embodiment shown in FIG. 8, the sensors 200 are coupled to the frame 110. More specifically, the proximal end 202 of the sensors 200 is coupled to the frame 110 (e.g., via the bracket 220). In this arrangement, the sensors 200 are indirectly coupled to the plate 114 (e.g., via the frame 110). By way of example, the sensors 200 may be coupled to the frame 110 below the plate 114. As shown in FIG. 2, at least a portion of the sensors 200 extend through the plate aperture 116 defined by the plate 114. In this way, the sensors 200 extend away from the frame 110, through the plate aperture 116, and in a direction towards the burner assembly 130.

In an example embodiment, the sensors 200 are coupled (e.g., communicably coupled) to a control unit or device, such as a controller (not shown). More specifically, a proximal end of the sensors 200 is coupled to the controller (e.g., via one or more cables, wires, circuits, etc.). By way of example, the controller may be configured to receive the data acquired by the sensors 200 (e.g., the data acquisition component of the sensors 200) and provide the data on a display (e.g., a display mounted on the griddle 100, a display of a user device, such as a smartphone, or other suitable display device).

In the embodiment shown in FIG. 2, the one or more sensors 200 extend axially through a burner aperture 144 defined through a portion of the burner assembly 130, such that the distal end of the one or more sensors 200 is positioned proximate the griddle body 120. In these embodiments, the plate aperture 116 is aligned with the burner aperture 144 defined through the burner assembly 130, such that each of the sensors 200 extend through both a corresponding aperture defined by the plate 114 and a corresponding burner aperture 144 defined through the corresponding burner assembly 130. In some embodiments, the distal end of the sensors 200 contacts the griddle body 120. In other embodiments, the distal end of the sensors 200 is spaced away from the griddle body 120.

The sensors 200 are positioned along an axis that extends outward from the frame 110 and/or outward from the plate 114 and through the plate aperture 116 and/or through the burner aperture 144, such that each sensor 200 is coupled to the frame 110 directly below the burner aperture 144 of the corresponding burner assembly 130. Similarly, the plate aperture 116 is positioned directly below the burner aperture 115 of the corresponding burner assembly 130. In some embodiments, the axis is defined by the burner aperture 144. More specifically, the axis may extend through a center of the burner aperture 144, such that each sensor 200 extends through the center of the burner aperture 144 of the corresponding burner assembly 130. The axis is substantially perpendicular to a surface (e.g., a top surface, a bottom surface) of the burner assemblies 130.

In any of the above-described embodiments, the positioning of the sensors 200 provides several benefits. By way of example, because the sensors 200 are positioned through the burner aperture 144 of the burner assemblies 130, the sensors 200 are positioned away from a flame produced around an outer periphery of the burner assemblies 130, such that the position of the sensors 200 avoids interference between the flame and the sensors 200.

Additionally, the above-described arrangement provides several advantages over conventional griddles. By way of example, this arrangement beneficially allows for more temperature sensors to be positioned within the internal volume of the griddle 100 (e.g., compared to conventional griddles). By way of another example, this arrangement beneficially allows for adjacent burner assemblies 130 to be positioned closer to each other and/or for uniform or substantially uniform spacing between adjacent burner assemblies 130. That is, compared to conventional griddles, which may have non-uniform spacing between heating elements due to sensors being positioned laterally away from heating elements and/or between adjacent heating elements, the burner assemblies 130 of the griddle 100 are positioned with uniform or substantially uniform spacing between adjacent burner assemblies 130. Additionally, this arrangement provides for uniform or substantially uniform spacing between adjacent sensors 200 (e.g., because the sensors 200 are each aligned with a corresponding burner assembly 130, which are also uniformly or substantially uniformly spaced).

Furthermore, the position of the sensors 200 allows for improved correspondence between the acquired temperature data and respective burner assemblies 130. That is, each of the sensors 200 are positioned to acquire data regarding a temperature of a portion of the griddle body 120 that the corresponding burner assembly 130 (e.g., the burner assembly through which the sensor 200 extends) is heating. In this way, the sensors 200 can acquire temperature data regarding a specific area or zone of the griddle body 120 that is heated by the burner assembly 130 through which the sensor 200 extends, which ultimately provides for better temperature zone control via the corresponding burner assembly 130.

According to an example embodiment, the griddle body 120 includes a first surface (e.g., a food preparation surface, a top surface, etc.). The first surface faces upwards, away from the burner assemblies 130. The griddle body 120 is configured to receive a food product thereon. More specifically, the griddle body 120 is configured to receive the food product on the first surface. The griddle body 120 is configured to be heated by combustion of the fuel at the burner assemblies 130 and transfer of the resulting heat to the food product. By way of example, the griddle body 120 may be made from a metallic material, such as steel (e.g., carbon rolled steel, powder coated steel, stainless steel, etc.), and the metallic material may facilitate transferring the heat produced by the combustion of the fuel to the food product received on the top surface of the griddle body 120.

According to an example embodiment, the griddle body 120 is removably coupled to the frame 110. By way of example, an operator may remove the griddle body 120 from the frame 110 in order to access the components of the griddle 100 that are beneath the griddle body 120, such as the burner assemblies 130 and/or the sensors 200. Advantageously, the sensors 200 are not coupled to the griddle body 120, such that the griddle body 120 can be removed from the frame 110, without decoupling the sensors 200 from the frame 110 and without decoupling the sensors 200 from the griddle body 120.

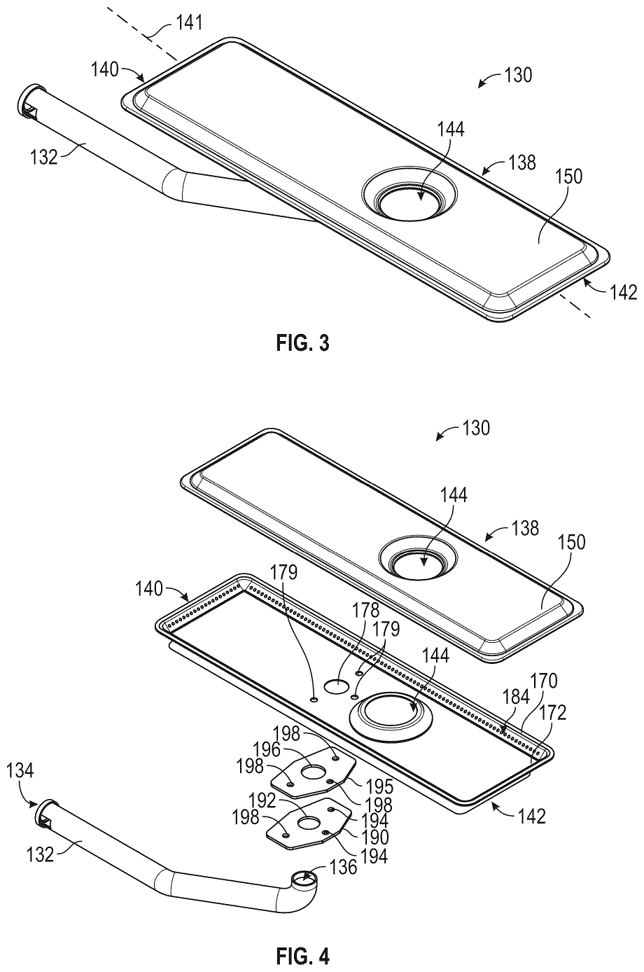

FIGS. 3-7, depicts a various views of the burner assembly 130 and/or the components thereof, according to an example illustrative embodiment. As shown in FIGS. 3, 4, and 7, the burner assembly 130 includes a fuel delivery portion, shown as a burner tube 132 (e.g., an offset burner tube), and a fuel routing portion, shown as a burner body 138. The burner body 138 includes a first portion, shown as an upper body portion 150 (shown in FIGS. 3, 4, 5, and 7), and a second portion, shown as a lower body portion 170 (shown in FIGS. 4, 6, and 7).

As shown in FIG. 4, the burner tube 132 has a burner tube first end 134 and a burner tube second end 136, opposite the burner tube first end 134. According to an example embodiment, the burner tube 132 is coupled to the frame 110. For example, the burner tube 132 may be coupled to the frame 110 at or proximate the burner tube first end 134.

In some embodiments, the burner tube 132 is coupled to a fuel tank or a fuel line (e.g., via a conduit, a tube, etc.), such that the burner tube 132 is in fluid (e.g., fuel) receiving communication with the fuel tank or the fuel line. For example, the burner tube 132 may receive the fuel at the burner tube first end 134.

The burner tube 132 is positioned below the burner body 138. The burner tube 132 is coupled to the burner body 138 at or proximate the burner tube second end 136. The burner tube 132 is configured to facilitate delivering the fuel to the burner body 138. That is, the burner tube 132 is in fuel providing communication with the burner body 138.

As shown in FIGS. 3 and 4, the burner tube first end 134 is offset from the burner tube second end 136 in a lateral direction. Additionally, the burner tube first end 134 is offset from a longitudinal axis 141 that extends longitudinally through the burner body 138 (e.g., from the first end 140 to the second end 142).

As shown in FIGS. 3 and 4, the burner body 138 has a burner body first end 140 and a burner body second end 142, opposite the burner body first end 140. The burner body 138 defines the burner aperture 144. The burner aperture 144 is positioned between the burner body first end 140 and the burner body second end 142.

According to an example embodiment, the burner body 138 is coupled to the burner tube 132. The burner tube 132 is coupled to the burner body 138 at a burner body central portion of the burner body, between the burner body first end 142 and the burner body second end 142. More specifically, the burner tube 132 is coupled to the burner body 138 between the burner aperture 144 and the burner body first end 142. Said another way, the burner aperture 144 is positioned between the burner body central portion the burner body second end 142.

As described above, the sensors 200 extend through the burner aperture 144 and extend towards the griddle body 120. In this way, the sensors 200 are positioned to acquire temperature data regarding the griddle body 120. By way of example, because the sensors 200 are not coupled to the griddle body 120, the griddle body 120 can be removed from the frame 110, without decoupling the sensors 200 from the frame 110 and without decoupling the sensors 200 from the griddle body 120. Accordingly, the burner aperture 144 advantageously allows the sensors 200 to be positioned to acquire temperature data regarding the griddle body 120 while allowing the griddle body 120 to be removed from the frame 110 without interacting with the sensors 200.

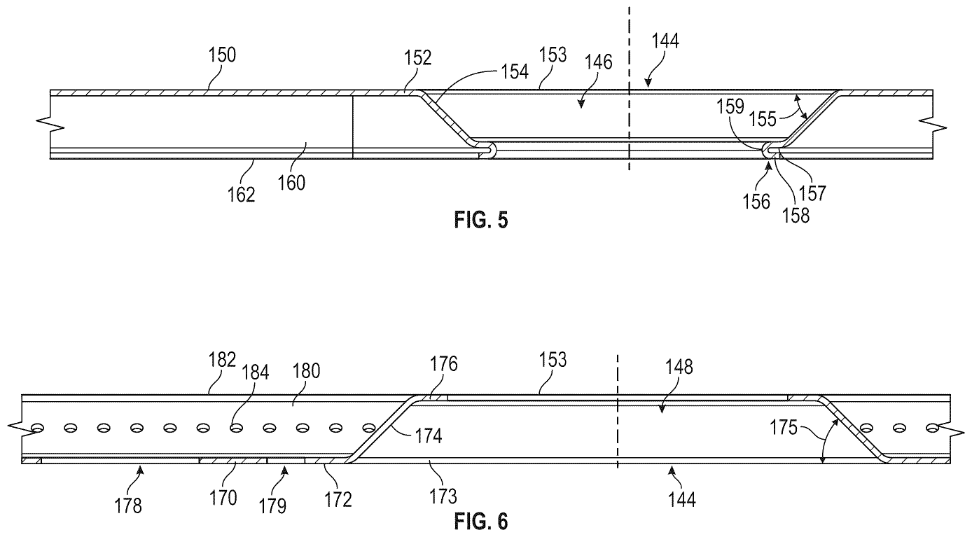

The upper body portion 150 is coupled to the lower body portion 170. The upper body portion 150 and the lower body portion 170 cooperate to define the burner body 138. A burner body volume is defined between the upper body portion 150 and the lower body portion 170. As shown in FIGS. 3 and 4, the upper body portion 150 is positioned above the lower body portion 170. As shown in FIG. 5, the upper body portion 150 includes first portion (e.g., a horizontal portion, a flat portion, etc.), shown as an upper body end wall 152, an second portion (e.g., an angled portion, etc.), shown as an upper body inner skirt 154, and a third portion (e.g., a curved portion, a coupling portion etc.) shown as an upper body flange 156. The upper body portion 150 also includes an upper body outer skirt 160 and an upper body outer flange 162.

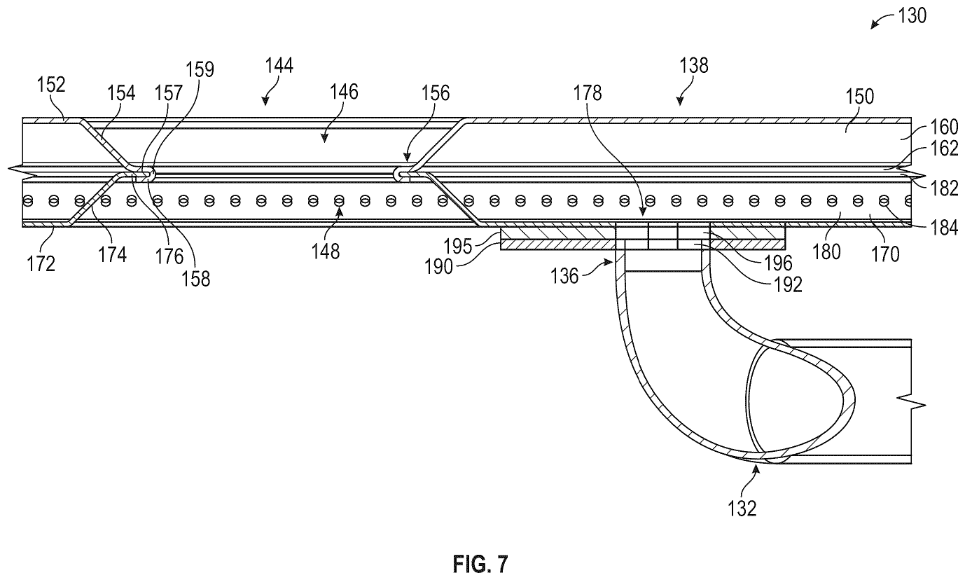

As shown in FIGS. 5 and 7, the upper body end wall 152 is a substantially flat surface of the upper body portion 150. For example, the upper body end wall 152 may be substantially horizontal. The upper body end wall 152 has an upper body end wall inner surface 153 that at least partially defines the burner aperture 144.

As shown in FIGS. 5 and 7, the upper body inner skirt 154 extends inward from the upper body end wall inner surface 153 and towards the lower body portion 170. The upper body inner skirt 154 is angled with respect to an extending direction of the upper body end wall 152. For example, an angle 155 between the extending direction of the upper body end wall 152 and the upper body inner skirt 154 may be between 0° and 90°.

As shown in FIGS. 5 and 7, the upper body inner flange 156 extends inward from the upper body inner skirt 154. The upper body inner flange 156 is configured to facilitate coupling the upper body portion 150 to the lower body portion 170. The upper body inner flange 156 includes two flat or horizontal portions, shown as a first flange portion 157 and a second flange portion 158, and a curved portion, shown as a third flange portion 159. The first flange portion 157 is substantially parallel to and spaced away from the second flange portion 158, such that a gap is formed between the first flange portion 157 and the second flange portion 158. The third flange portion 159 extends between the first flange portion 157 and the second flange portion 158 at an inner side of the upper body inner flange 156.

According to an example embodiment, the upper body end wall 152, the upper body inner skirt 154, and/or the upper body inner flange 156 cooperate to define an upper portion 146 of the burner aperture 144. As shown in FIG. 5, the upper portion 146 of the burner aperture 144 is frustoconical in shape.

As shown in FIGS. 5 and 7, the upper body outer skirt 160 extends outward from an outer perimeter of the upper body end wall 152 and towards the lower body portion 170. The upper body outer flange 162 extends outward from the upper body outer skirt 160. The upper body outer flange 162 is configured to facilitate coupling the upper body portion 150 to the lower body portion 170.

As shown in FIGS. 6 and 7, the lower body portion 170 includes first portion (e.g., a horizontal portion, a flat portion, etc.), shown as a lower body end wall 172, an second portion (e.g., an angled portion, etc.), shown as a lower body inner skirt 174, and a third portion (e.g., a curved portion, a coupling portion etc.) shown as an upper body flange 156. The lower body portion 170 also includes a lower body outer skirt 180 and a lower body outer flange 182.

As shown in FIGS. 4, 6, and 7, the lower body end wall 172 is a substantially flat surface of the lower body portion 170. For example, the lower body end wall 172 may be substantially horizontal. The lower body end wall 172 has a lower body end wall inner surface 173 that at least partially defines the burner aperture 144.

As shown in FIGS. 4, 6, and 7, the lower body end wall 172 defines a second aperture 178. The second aperture 178 is positioned between the first burner aperture 144 and the burner body first end 140. The burner tube 132 is coupled to the burner body 138 at the second aperture 178. In this way, the second aperture 178 enables fluid communication between the burner tube 132 and the burner body 138, and, more specifically, the burner body volume.

As shown in FIGS. 4, 6, and 7, the lower body end wall 172 defines one or more third apertures 179. The one or more third apertures 179 are positioned proximate the second aperture 178. The one or more third apertures 179 are configured to facilitate coupling the burner tube 132 to the burner body 138. For example, the one or more third apertures 179 may be configured to receive a fastener that couples the burner tube 132 to the burner body 138.

As shown in FIGS. 6 and 7, the lower body inner skirt 174 extends inward from the lower body end wall inner surface 173 and towards the upper body portion 150. The lower body inner skirt 174 is angled with respect to an extending direction of the lower body end wall 172. For example, an angle 175 between the extending direction of the lower body end wall 172 and the upper body inner skirt 174 may be between 0° and 90°.

As shown in FIGS. 6 and 7, the lower body inner flange 176 extends inward from the lower body inner skirt 174. The lower body inner flange 176 is configured to facilitate coupling the lower portion 170 to the upper body portion 150. In an example embodiment, the lower body inner flange 176 is coupled to the upper body inner flange 156. For example, the lower body inner flange 176 may extend into the gap that is formed between the first flange portion 157 and the second flange portion 158 of the upper body inner flange 156. The coupling between the lower body inner flange 176 and the upper body inner flange 156 substantially prevents a fluid from flowing out of the burner body volume through the burner aperture 144. Beneficially, the coupling between the lower body inner flange 176 and the upper body inner flange 156 around the burner aperture 144 improves (e.g., increases) the rigidity of the burner body 138.

According to an example embodiment, the lower body end wall 172, the lower body inner skirt 174, and the lower body inner flange 176 cooperate to define a lower portion 148 of the burner aperture 144. As shown in FIG. 6, the lower portion 148 of the aperture is frustoconical in shape.

As shown in FIGS. 6 and 7, the lower body outer skirt 180 extends outward from an outer perimeter of the lower body end wall 172 and towards the upper body portion 150. The lower body outer skirt 180 defining a plurality of apertures 184 positioned around a perimeter of the lower body outer skirt 180. The plurality of apertures 184 each enable fluid communication between the burner body volume and an outside of the burner body 138. For example, the fuel may flow from within the burner body volume, through the plurality of apertures 184, and outside of the burner body 138. According to an example embodiment, when the fuel flows out of the burner body 138 (e.g., via the plurality of apertures 184), the fuel is combusted to produce heat.

The lower body outer flange 182 extends outward from the lower body outer skirt 180. The lower body outer flange 182 is configured to facilitate coupling the lower body portion 170 to the upper body portion 150. For example, the lower body outer flange 182 may be coupled to the upper body outer flange 162.

As shown in FIGS. 4 and 7, the griddle 100 includes a plate 190 and a sealing member 195. The plate 190 and the sealing member 195 are configured to facilitate coupling the burner tube 132 to the burner body 138.

According to an example embodiment, the plate 190 is coupled to the burner tube 132. For example, the plate 190 may be welded to the burner tube 132. The plate 190 defines a first plate aperture 192 that is configured to enable fluid communication between the burner tube 132 and the burner body 138.

The plate 190 defines one or more second plate apertures 194 that are positioned proximate the first plate aperture 192. The one or more second plate apertures 194 are configured to facilitate coupling the burner tube 132 to the burner body 138. For example, each of the one or more second plate apertures 194 may be configured to align with one of the one or more third apertures 179 of the lower body portion 170, such that the one or more second plate apertures 194 each receive the fasteners that couple the burner tube 132 to the burner body 138. More specifically, the fasteners couple the plate 190 to the burner body 138, and, because the plate 190 is coupled to the burner tube 132, the fasteners couple the burner tube 132 to the burner body 138.

According to an example embodiment, the sealing member 195 is positioned between the plate 190 and the burner body 138. The sealing member 195 is configured to form a seal between the plate 190 and the burner body 138, such that the fuel flowing through the burner tube 132 is substantially prevented from flowing out of the burner tube 132 between the burner tube 132 and the burner body 138. Said another way, the sealing member 195 facilitates directing the fuel from flowing through the burner tube 132 and into the burner body 138.

The sealing member 195 defines a first sealing member aperture 196 that is configured to enable fluid communication between the burner tube 132 and the burner body 138. The sealing member 195 defines one or more second sealing member apertures 198 that are positioned proximate the first sealing member aperture 196. The one or more second sealing member apertures 198 are configured to facilitate coupling the burner tube 132 to the burner body 138. For example, each of the one or more second sealing member apertures 196 may be configured to align with one of the one or more third apertures 179 of the lower body portion 170, such that the one or more second sealing member apertures 198 each receive the fasteners that couple the burner tube 132 to the burner body 138.

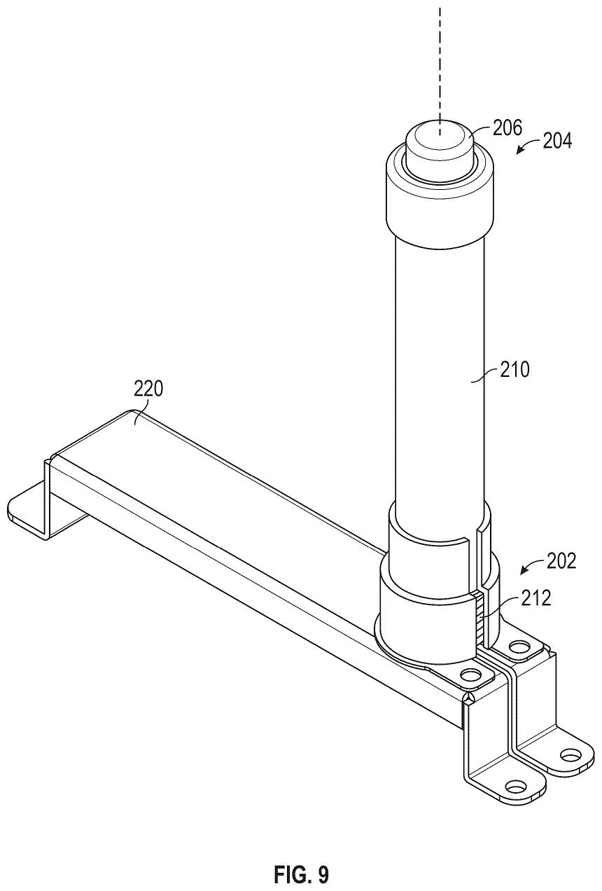

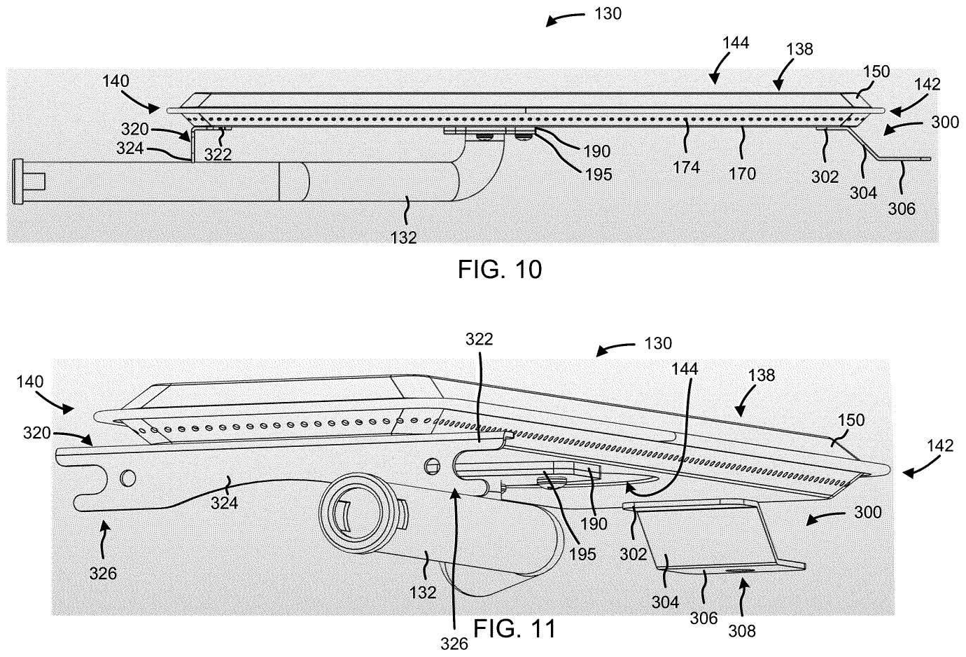

FIGS. 10 and 11 are a side view and a perspective view of the burner assembly 130 of FIG. 3, shown in a first configuration. In the configuration shown, the burner assembly 130 includes the upper body portion 150 and the lower body portion 170. The burner assembly 130 may also include the burner tube 132, the plate 190, and the sealing member 195. The burner assembly 130 also includes a first mounting bracket 300 and an igniter bracket 320.

The first mounting bracket 300 is configured to couple the burner body 138 to the frame 110 of the griddle 100. For example, the first mounting bracket 300 may be coupled to a bottom surface of the burner body 138 and the frame 110.

As shown in FIGS. 10 and 11, the first mounting bracket 300 is coupled to the burner body 138. More specifically, the first mounting bracket 300 is coupled to a bottom surface of the lower body portion 170. The first mounting bracket 300 is coupled to the lower body portion 170 between the burner aperture 144 and the burner body second end 142.

The first mounting bracket 300 includes a first portion (e.g., a first end portion) shown as an burner coupling portion 302, a second portion (e.g., a central portion) shown as an angled portion 304, and a third portion (e.g., a second end portion) shown as a frame coupling portion 306. In some embodiments, the first mounting bracket 300 is formed as a single, contiguous part, such that the burner coupling portion 302, the angled portion 304, and the frame coupling portion 306 are monolithically formed. In other embodiments, the angled portion 304 couples the burner coupling portion 302 to the frame coupling portion 306.

The burner coupling portion 302 is coupled to the lower body portion 170 between the burner aperture 144 and the burner body second end 142. The burner coupling portion 302 extends in the horizontal direction, substantially parallel to the lower body end wall 172.

The angled portion 304 is contiguous with the burner coupling portion 302. The angled portion 304 extends away from the burner coupling portion 302 in a first direction at a non-zero angle with respect to the horizontal direction and towards the burner body second end 142. By way of example, the non-zero angle can be between 0° and 90°, such that the angled portion 304 is angled with respect to the horizontal direction and a vertical direction.

A first end of the angled portion 304 is located proximate the burner coupling portion 302. A second end of the angled portion 304 is located away from the burner coupling portion 302. In some embodiments, the second end of the angled portion 304 extends past the burner body second end 142. In other embodiments, the second end of the angled portion 304 is positioned between the first end of the angled portion 304 and the burner body second end 142. In still other embodiments, the second end of the angled portion 304 is positioned vertically below the burner body second end 142.

The frame coupling portion 306 is contiguous with the angled portion 304. The frame coupling portion 306 extends away from the angled portion 304 in the horizontal direction. The frame coupling portion 306 extends away from the burner body second end 142 and towards the frame 110 of the griddle 100. In some embodiments, the frame coupling portion 306 defines a mounting bracket aperture 308 extending vertically therethrough. The mounting bracket aperture 308 is sized to receive a fastener (e.g., a bolt, a screw, a pin, etc.). By way of example, the frame 110 may include a receiver portion positioned to receive the frame coupling portion 306. The fastener may couple the first mounting bracket 300 to the receiver portion. In this way, the first mounting bracket 300 facilitates coupling the burner body 138 to the frame 110.

Still referring to FIGS. 10 and 11, the burner assembly 130 includes the igniter bracket 320. The igniter bracket 320 is configured to couple an igniter (not shown) to the burner body 138. The igniter bracket 320 is coupled to the burner body 138. More specifically, the igniter bracket 320 is coupled to a bottom surface of the lower body portion 170. The igniter bracket 320 is coupled to the lower body portion 170 proximate the burner body first end 140.

The igniter bracket 320 includes a first portion (e.g., a first end portion) shown as an coupling portion 322 and a second portion (e.g., a second end portion) shown as an igniter holder 324. In some embodiments, the igniter bracket 320 is formed as a single, contiguous part, such that the coupling portion 322 and the igniter holder 324 are monolithically formed. In other embodiments, the coupling portion 322 is coupled to the igniter holder 324.

The coupling portion 322 is coupled to the lower body portion 170, proximate the burner body first end 140. The coupling portion 322 extends in the horizontal direction, substantially parallel to the lower body end wall 172.

The igniter holder 324 is contiguous with the coupling portion 322. The igniter holder 324 extends away from the angled portion 304 in a substantially vertical direction (e.g., such that the igniter holder 324 is substantially perpendicular to the coupling portion 322), away from the lower body portion 170. In some embodiments, the igniter holder 324 includes one or more fingers 326 extending in the horizontal direction. The one or more fingers 326 are configured to support the igniter. By way of example, the igniter can be positioned between the one or more fingers 326. In some embodiments, the igniter is positioned to ignite a fuel exiting the burner body 138 (e.g., via the plurality of apertures 184).

In some embodiments, the griddle 100 may include one igniter for each burner assembly 130. That is, each burner assembly 130 has a corresponding igniter that is configured to ignite fuel exiting the burner body 138 (e.g., via the plurality of apertures 184). In these embodiments, because the plurality of apertures 184 extend around the perimeter of the lower body portion 170, only a single igniter is needed to ignite the fuel for each burner assembly 130.

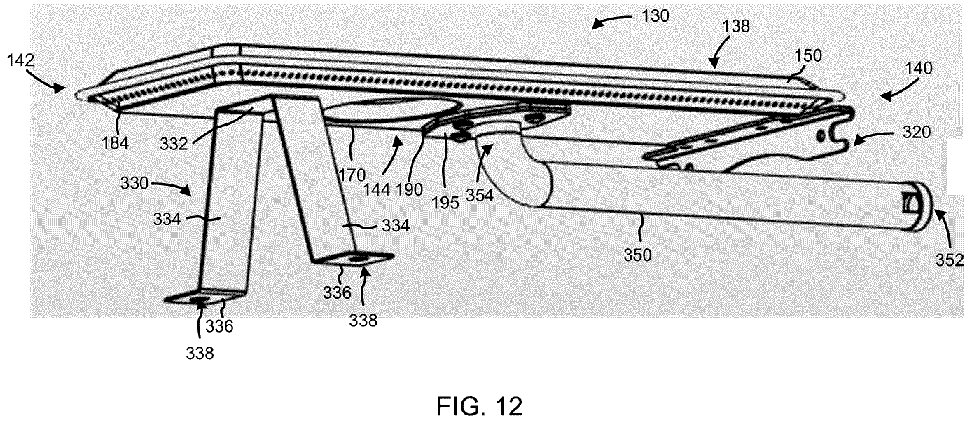

FIG. 12 is a perspective view of the burner assembly of FIG. 3, shown in a second configuration. In the configuration shown, the burner assembly 130 includes the upper body portion 150 and the lower body portion 170. The burner assembly 130 may also include a burner tube 350 (e.g., an inline burner tube), the plate 190, and the sealing member 195. The burner assembly 130 also includes a second mounting bracket 330 and the igniter bracket 320.

The second mounting bracket 330 is configured to couple the burner body 138 to the plate 114 of the griddle 100. For example, the second mounting bracket 330 may be coupled to a bottom surface of the burner body 138 and the plate 114.

As shown in FIG. 12, the second mounting bracket 330 includes a first portion (e.g., a first end portion) shown as an burner coupling portion 332, one or more second portions (e.g., a central portion) shown as angled portions 334, and one or more third portions (e.g., a second end portion) shown as plate coupling portions 336. In some embodiments, the second mounting bracket 330 is formed as a single, contiguous part, such that the burner coupling portion 332, the angled portions 334, and the plate coupling portions 336 are monolithically formed. In other embodiments, the angled portions 334 couple corresponding plate coupling portions 336 to the burner coupling portion 332. In the embodiment shown, the second mounting bracket 330 includes two angled portions 334 and two plate coupling portions 336, such that the second mounting bracket 330 has an upside down “U” shape.

The burner coupling portion 332 is coupled to the lower body portion 170 between the burner aperture 144 and the burner body second end 142. The burner coupling portion 332 extends in the horizontal direction, substantially parallel to the lower body end wall 172.

The angled portions 334 are each contiguous with the burner coupling portion 332. Each of the angled portions 334 extend away from the burner coupling portion 332 at a non-zero angle with respect to the horizontal direction and towards the plate 114. By way of example, the non-zero angle can be between 0° and 90°, such that the angled portions 334 are each angled with respect to the horizontal direction and the vertical direction.

A first end of each of the angled portions 334 is located proximate the burner coupling portion 332. A second end of each of the angled portions 334 is located away from the burner coupling portion 332.

The plate coupling portions 336 is contiguous with the angled portions 334. The plate coupling portions 336 extends away from the angled portions 334 in the horizontal direction. The plate coupling portions 336 extends away from the burner body second end 142 and towards the plate 114 of the griddle 100. In some embodiments, each of the angled portions 334 defines a mounting bracket aperture 338 extending vertically therethrough. The mounting bracket apertures 338 are each sized to receive a fastener (e.g., a bolt, a screw, a pin, etc.). By way of example, and as shown in FIG. 2, the fastener may couple the plate coupling portions 336 to the plate 114 of the griddle 100. In this way, the second mounting bracket 330 facilitates coupling the burner body 138 to the plate 114.

As shown in FIG. 12, the burner tube 350 has a burner tube first end 352 and a burner tube second end 354, opposite the burner tube first end 352. According to an example embodiment, the burner tube 350 is coupled to the frame 110. For example, the burner tube 350 may be coupled to the frame 110 at or proximate the burner tube first end 352.

In some embodiments, the burner tube 350 is coupled to a fuel tank or a fuel line (e.g., via a conduit, a tube, etc.), such that the burner tube 350 is in fluid (e.g., fuel) receiving communication with the fuel tank or the fuel line. For example, the burner tube 350 may receive the fuel at the burner tube first end 352.

The burner tube 350 is positioned below the burner body 138. The burner tube 350 is coupled to the burner body 138 at or proximate the burner tube second end 354. The burner tube 350 is configured to facilitate delivering the fuel to the burner body 138. That is, the burner tube 350 is in fuel providing communication with the burner body 138.

As shown in FIG. 12, the burner tube first end 352 is aligned with the burner tube second end 354 in the lateral direction. Additionally, the burner tube first end 352 is laterally aligned with the longitudinal axis 141 that extends longitudinally through the burner body 138 (e.g., from the first end 140 to the second end 142).

As shown in FIG. 12, the plate 190 and the sealing member 195 are configured to facilitate coupling the burner tube 350 to the burner body 138. According to an example embodiment, the plate 190 and the sealing member 195 couple the burner tube 350 to the burner body 138 in the same way that the plate 190 and the sealing member 195 couple the burner tube 132 to the burner body 138.

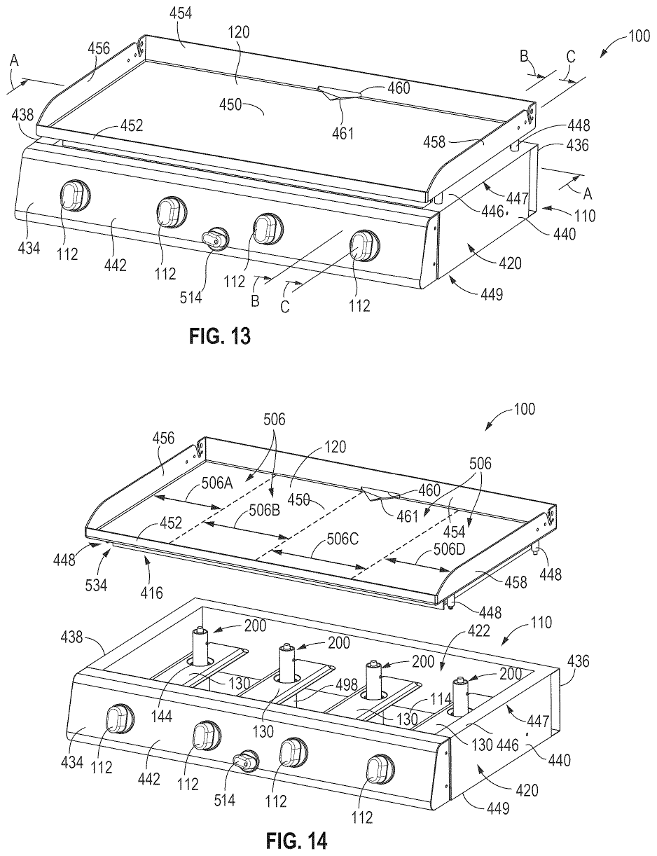

Referring generally to FIG. 13-21, the griddle 100 is shown according to another example embodiment. It should be understood that any of the features of the griddle 100 shown and described with respect to the griddle 100 shown in FIGS. 1 and 2 may be present in the of the griddle 100 shown in FIG. 13-21. Furthermore, any of the features of the burner assemblies 130 and/or the sensors 200 shown a described with respect to FIGS. 3-12 may be used with the griddle 100 shown in FIG. 13-21. Similarly, any of the features of the griddle 100 shown and described with respect to FIGS. 13-21 may be used in the griddle 100 shown in FIGS. 1 and 2 and/or in the burner assemblies 130 and/or in the sensors 200 shown in FIGS. 3-12.

As shown in FIGS. 13 and 14, the griddle 100 includes the frame 110, the burner assemblies 130 (shown in FIG. 14), and one or more sensors 200 (shown in FIG. 14). The griddle 100 also includes the griddle body 120, the knobs 112, and the plate 114.

In an example embodiment, the sensors 200 are configured to acquire data regarding a temperature of an underside 416 of the griddle body 120 at locations corresponding with burner assemblies 130. The sensors 200 may be configured to acquire data regarding the temperature of a portion or zone (e.g., a cooking zone) of the griddle body 120. The portions or zones of the griddle body 120 correspond with the number of burner assemblies 130. In one example, if a griddle 100 has four burners for heating the griddle body 120, then the griddle body 120 includes four zones, and each zone has a corresponding sensor 200. In another example, if a griddle 100 has three burners for heating the griddle body 120, then the griddle body 120 includes three zones, and each zone has a corresponding sensor 200.

The frame 110 of the griddle 100 includes one or more frame components shown as one or more panels 420. The one or more panels 420 cooperate to at least partially define the internal volume 422 of the griddle 100.

As shown in FIGS. 13 and 14, the one or more panels 420 include a first lateral panel shown as a front panel 434, a second lateral panel shown as a rear panel 436, a first longitudinal panel shown as a left panel 438, and a second longitudinal panel shown as a right panel 440. The front panel 434 and the rear panel 436 extend in a substantially lateral direction such that the front panel 434 and the rear panel 436 are substantially parallel to one another. The left panel 438 and the right panel 440 extend in a substantially longitudinal direction such that the left panel 438 and the right panel 440 are substantially parallel to one another. The front panel 434 and the rear panel 436 are substantially perpendicular to the left panel 438 and the right panel 440. In some embodiments, the front panel 434 is or includes a control panel 442. The control panel 442 may include the knobs 112.

As shown in FIGS. 13 and 14, the front panel 434, the rear panel 436, the left panel 438, and the right panel 440 cooperate to at least partially define the internal volume 422 of the griddle 100. In some embodiments, the internal volume 422 of the griddle 100 is or includes a burn box inside which combustion of fuel occurs.

As shown in FIGS. 13 and 14, the front panel 434, the rear panel 436, the left panel 438, and the right panel 440 extend vertically between an upper periphery 447 and a lower periphery 449 of the frame 110. The upper periphery 447 defines a ledge 446 that has an upward facing surface that extends horizontally relative to the vertically extending panels 420. Further, the ledge 446 may be sized and configured for griddle feet 448 (shown in FIG. 14) of the griddle body 120 to be positioned thereon or may include openings (not shown) defined therein configured to receive the griddle feet 448.

As shown in FIG. 14, the griddle body 120 includes the underside 416. The griddle feet 448 may be coupled to and/or extend from the underside 416 of the griddle body 120. When the griddle feet 448 are positioned on or over the ledge 446, the griddle body 120 is supported by the frame 110, and the griddle body 120 is positioned above the burner assemblies 130.

As shown in FIGS. 13 and 14, the griddle body 120 also includes top surface shown as a cooking surface 450, a first vertical surface shown as a front splash guard 452, a second vertical surface shown as a rear splash guard 454, a third vertical surface shown as a left splash guard 456, and a fourth vertical surface shown as a right splash guard 458. The front splash guard 452, the rear splash guard 454, the left splash guard 456, and the right splash guard 458 each extend upward from the periphery of the cooking surface 450.

As shown in FIGS. 13 and 14, the griddle body 120 includes an opening 460 defined therein. The opening 460 is configured to facilitate food byproduct (e.g., grease) to drain therethrough. The griddle body 120 also includes a sloped surface 461 that slopes downward from the cooking surface 450 and is positioned proximate the opening 460, such that the sloped surface 461 directs the grease to flow from the cooking surface 450 through the opening 460. As shown in FIGS. 13 and 14, the opening 460 is positioned adjacent to the rear splash guard 454. By way of example, the rear splash guard 454 at least partially defines opening 460.

As shown in FIG. 14, the griddle body 120 defines one or more burner zones 506 or cooking zones, shown as first burner zone 506A, second burner zone 506B, third burner zone 506C, and fourth burner zone 506D, each of the burner zones 106 corresponding with one of the burner assemblies 130 and one of the knobs 112. As such, the number of burner zones 506 correspond with the total number of burner assemblies 130 and knobs 112.

The burner zone 506 is an area or region of the griddle body 120 positioned relative to (e.g., above) a corresponding burner assembly 130. For example, in the embodiment shown in FIG. 14, there are four knobs 112 and four burner assemblies 130 and, thus, there are four burner zones 506 (e.g., the first burner zone 506A, the second burner zone 506B, the third burner zone 506C and the fourth burner zone 506D). Each of the burner zones 506 may be defined by the area on the griddle body 120 that is directly heated by a corresponding burner assembly 130. The area of each burner zone 506 is generally rectangular so as to be positioned relative to (e.g., above) the corresponding burner assembly 130.

Each of the sensors 200 is positioned to acquire data regarding a temperature of the griddle body 120 at or proximate a corresponding burner zone 506. By way of example, each of the sensors 200 may be positioned laterally and longitudinally within a corresponding burner zone 506 and vertically below the corresponding burner zone 506.

As shown in FIG. 14, plate 114 is coupled to the front panel 434, the rear panel 436, the left panel 438, and the right panel 440 and is positioned adjacent the lower periphery 449 of the burn box 13. The plate 114 is positioned below the burner assemblies 130. The plate 114 defines a bottom side of the internal volume 422. The plate 114 is substantially parallel to the griddle body 120.

As shown in FIGS. 16 and 17, each of the burner assemblies 130 of the griddle 100 (in the second configuration) includes the inline burner tube 350. The burner tube 350 extends from the burner body 138 toward the front panel 434. Each burner tube 350 may correspond with one of the knobs 112 and one of the burner bodies 138.

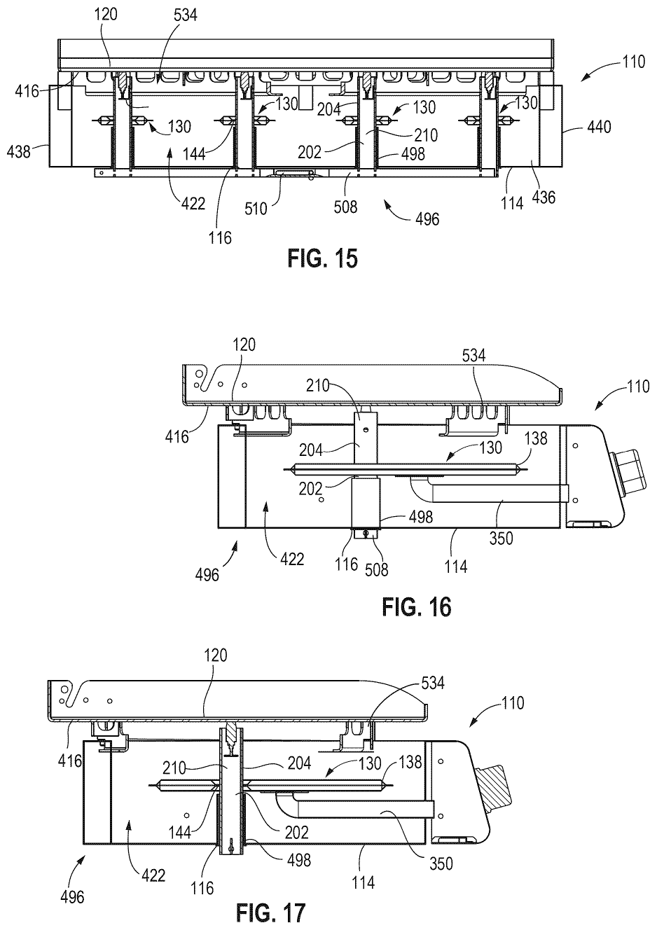

As shown in FIGS. 15-21, the sensors 200 are repositionable between a first position (e.g., a raised position, shown in FIGS. 15-18 and 21) and a second position (e.g., a lowered position, shown in FIGS. 17-20). In the first position (e.g., the raised position), the housing 210 of the sensors 200 extends from the plate 114 towards the griddle body 120 and through the burner aperture 144, such that the data acquisition component 206 is positioned to contact or proximate the griddle body 120, such that the data acquisition component 206 is positioned to acquire data regarding the temperature of the griddle body 120. In the second position (e.g., the lowered position), the housing 210 of the sensors 200 is positioned below the burner assemblies 130, such that the housing 210 does not extend through the burner aperture 144, and the data acquisition component 206 is positioned away from the griddle body 120, such that the data acquisition component 206 is not positioned to acquire data regarding the temperature of the griddle body 120.

As shown in FIGS. 15-18, the housing 210 extends through the plate aperture 116 such that the proximal end 202 of the sensors 200 extends through the plate aperture 116 to an exterior 496 of the frame 110. The housing 210 extends through the plate aperture 116 when the sensors 200 are in the first position and when the sensors 200 are in the second position.

As shown in FIGS. 14-16 The plate 114 of the frame 110 may include a casing 498. The casing 498 is coupled to the plate 114 and extends towards the burner assemblies 130. The casing 498 is positioned on the plate 114 directly below the burner aperture 144 of the burner assemblies 130. The casing 498 is sized and configured to receive the proximal end 202 of the sensors 200 therein. The casing 498 is configured to align the proximal end 202 relative to the burner aperture 144 and the plate aperture 116 such that, as the housing 210 moves between the first position and the second position, the housing 210 translates in a substantially axial direction, and casing 498 substantially mitigates the housing 210 from engaging or contacting the burner assemblies 130.

As shown in FIGS. 15, 16, 18, 19, and 21, the griddle 100 includes a lateral bar 508. Each of the sensors 200 (or, more specifically, the housing 210 of each of the sensors 200) is coupled to the lateral bar 508 at the proximal end 202 of the sensors 200. The lateral bar 508 extends from the sensor 200 positioned closest to the left panel 438 and to each subsequent sensor 200, stopping at the sensor 200 positioned closest to the right panel 440. As shown in FIGS. 15, 18, and 19, the lateral bar 508 defines a bar opening 510 positioned on the center of the lateral bar 508. The bar opening 510 is positioned along the length of the lateral bar 508 between any of the sensors 200.

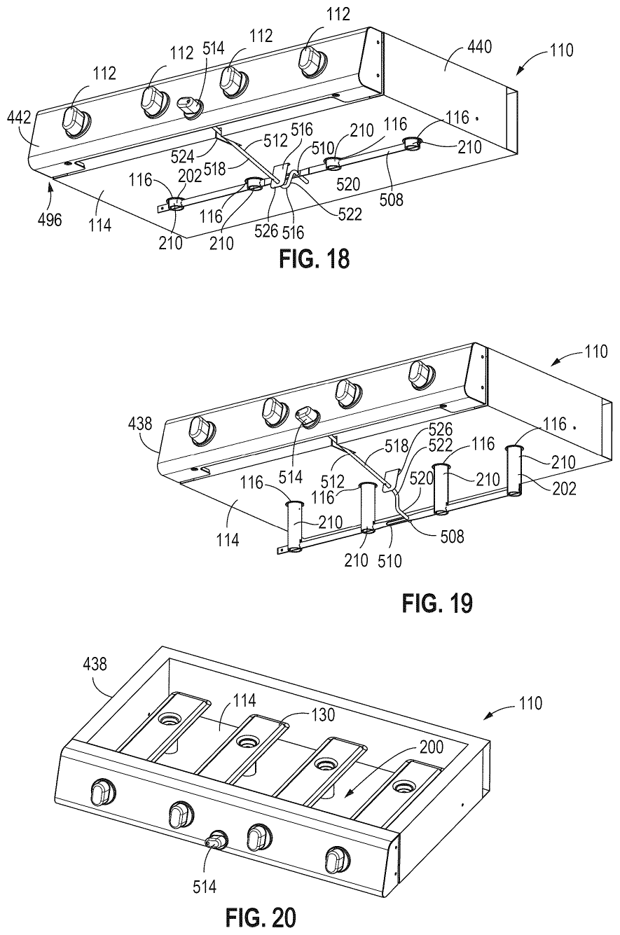

As shown in FIGS. 18 and 19, the griddle 100 includes a longitudinal bar 512. The longitudinal bar 512 extends from the control panel 442 to the lateral bar 508. The longitudinal bar 512 extends through the bar opening 510. The longitudinal bar 512 is substantially perpendicular to the lateral bar 508.

The longitudinal bar 512 includes a first portion 518, a second portion 520 spaced away from the first portion 518, and a connector portion 522 extending between the first portion 518 and the second portion 520. The first portion 518 is substantially parallel to the second portion 520. The connector portion 522 couples the first portion 518 to the second portion 520. The connector portion 522 is substantially perpendicular to the first portion 518 and the second portion 520. By way of example, bends 516 in the longitudinal bar 512 couple the connector portion 522 to the first portion 518 and the second portion 520.

As shown in FIGS. 13, 14 18, 19, and 20, the griddle 100 includes a lever knob 514. The lever knob 514 is positioned on the control panel 442 of the frame 110. The longitudinal bar 512 is coupled to the lever knob 514.

As shown in FIGS. 18 and 19, the plate 114 defines a bar slot 524 positioned proximate the front panel 434. In some embodiments, the front panel 434 at least partially defines the bar slot 524. The bar slot 524 is sized to receive at least a portion of the longitudinal bar 512 therethrough. By way of example, the longitudinal bar 512 may extend from the lever knob 514, through the bar slot 524, and towards the lateral bar 508.

As shown in FIGS. 18 and 19, griddle 100 includes a tab 526 extending outward from the plate 114, away from the griddle body 120. The tab 526 is positioned between the bar slot 524 and the lateral bar 508 and is aligned with the longitudinal bar 512. The tab 526 is configured to receive the longitudinal bar 512 therethrough. By way of example, the longitudinal bar 512 may extend through the tab 526 from the bar slot 524 to the bar opening 510 of the lateral bar 508.

As shown in FIGS. 14 and 18, when the sensors 200 are in the first position (e.g., the raised position), the first portion 518 is positioned below the second portion 520, and the connector portion 522 extends from the first portion 518, upwards towards the second portion 520. The second portion 520 is positioned proximate the plate 114. The second portion 520 extends through the bar opening 510, forcing the lateral bar 508 towards the plate 114, thereby locating the sensors 200 in the first position.

As shown in FIGS. 19 and 20, the sensors 200 are in the second position (e.g., the lowered position). In the second position, the sensors 200 are positioned below the burner assemblies 130, such that the sensors 200 do not extend through the corresponding burner apertures 144. When the sensors 200 are in the second position the first portion 518 is positioned proximate the plate 114 and is positioned above the second portion 520. The second portion 520 is positioned away from the plate 114. The second portion 520 extends through the bar opening 510, forcing the lateral bar 508 away the plate 114, thereby locating the sensors 200 in the second position.

In an example embodiment, the lateral bar 508, the bar opening 510, and the lever knob 514 are used to adjust the position of the sensors 200. By way of example, the lever knob 514 may be manipulated from a first knob position corresponding to the first position of the sensors 200 to a second knob position corresponding to the second position of the sensors 200. Starting in the first knob position, as the lever knob 514 is manipulated, the longitudinal bar 512 is rotated, causing the second portion 520 to move away from the plate 114. As the second portion 520 moves away from the plate 114, the lateral bar 508 moves away the plate 114, thereby lowering the sensors 200 from the first position to the second position. Starting in the second knob position, as the lever knob 514 is manipulated, the longitudinal bar 512 is rotated, causing the second portion 520 to move towards the plate 114. As the second portion 520 moves towards the plate 114, the lateral bar 508 moves towards the plate 114, thereby raising the sensors 200 from the second position to the first position.

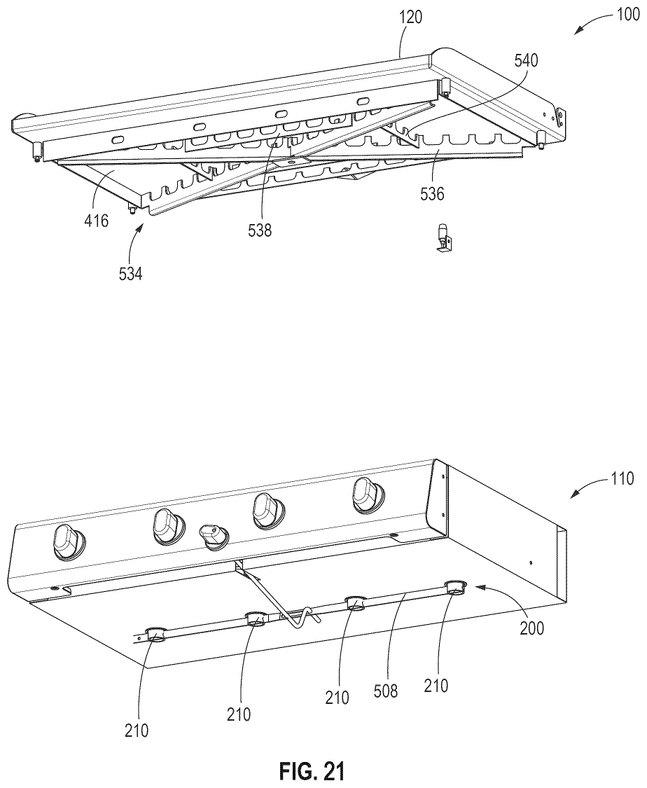

As shown in FIGS. 14, 15, 16, 17, and 21, the griddle 100 includes an understructure 534 coupled to the underside 416 of the griddle body 120. The understructure 534 is configured to mitigate warping of the griddle body 120 due to thermal expansion of the material of the griddle body 120 caused by the heat generated at the burner assemblies 130. As shown in FIG. 21, the understructure 534 includes one or more structures shown as diagonal structures 536, horizontal structures 538, and vertical structures 540. The diagonal structures 536, horizontal structures 538, and vertical structures 540 extend across the underside 416 of the griddle body 120. When the sensors 200 are in the first position, the sensors 200 are positioned to extend through the burner assemblies 130 (e.g., through the burner aperture 144 of each of the burner assemblies 130) and through the understructure 534 such that the sensors 200 contact the underside 416 of the griddle body 120.

The various structural components of the embodiments of the griddle 100 and the electrical components set forth herein may be formed from metallic materials, such as stainless steel, aluminum, copper, or any other suitable metallic material, or some components may be formed from one or more polymeric materials, such as cables, as well as any other materials needed to form and manufacture the various components of the griddle 100. Further, the structural components of the griddle 100 and electrical components thereof may be formed by employing manufacturing techniques and processes, such as welding, molding, milling, drilling, bending, fastening, soldering, etc.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges, relationships, or descriptions provided. Accordingly, these terms should be interpreted as indicating that insubstantial or inconsequential modifications or alterations of the subject matter described and claimed are considered to be within the scope of the disclosure as recited in the appended claims. The term “coupled” and the like as used herein mean the joining of two members directly to one another. Such joining may be stationary (e.g., permanent) or moveable (e.g., removable or releasable).

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An appliance comprising:
a chassis;
a griddle body coupled to the chassis;
a burner assembly coupled to the chassis, positioned below the griddle body, and spaced away from the griddle body, the burner assembly comprising:
a burner tube coupled to the chassis; and
a burner body coupled to the burner tube, the burner body having a burner body first end and a burner body second end, and the burner body defining a burner aperture positioned between the burner body first end and the burner body second end; and
a sensor coupled to the chassis and extending axially through the burner aperture, such that a distal end of the sensor is positioned proximate the griddle body.

2. The appliance of claim 1, wherein the burner tube is positioned below the burner body, the burner tube is configured to facilitate delivering a fuel to the burner body, and the burner tube is coupled to the burner body at a burner body central portion of the burner body, between the burner body first end and the burner body second end.

3. The appliance of claim 2, wherein the burner aperture is positioned between the burner body central portion and the burner body second end.

4. The appliance of claim 1, wherein the griddle body is removably coupled to the chassis.

5. The appliance of claim 1, wherein the burner body comprises:
an upper body portion including:
an upper body end wall having an upper body end wall inner surface that at least partially defines the burner aperture;
an upper body inner skirt extending inward from the upper body end wall inner surface of the upper body end wall; and
an upper body inner flange extending inward from the upper body inner skirt; and
a lower body portion including:
a lower body end wall having a lower body end wall inner surface that at least partially defines the burner aperture;
a lower body inner skirt extending inward from the lower body end wall inner surface of the lower body end wall; and
a lower body inner flange extending inward from the lower body inner skirt, the lower body inner flange coupled to the upper body inner flange, wherein a burner body volume is defined between the upper body portion and the lower body portion, and the coupling between the lower body inner flange and the upper body inner flange substantially prevents a fluid from flowing out of the burner body volume through the burner aperture.

6. The appliance of claim 5, wherein the upper body inner skirt, and the upper body inner flange cooperate to define an upper portion of the burner aperture, such that the upper portion of the burner aperture is frustoconical in shape.

7. The appliance of claim 5, wherein:
the burner aperture is a first burner aperture;
the lower body end wall defines a second burner aperture that enables fluid communication between the burner tube and the burner body volume;
the lower body portion further includes:
a lower body outer skirt extending outward from an outer perimeter of the lower body end wall, the lower body outer skirt defining a plurality of third burner apertures positioned around a perimeter of the lower body outer skirt and enabling fluid communication between the burner body volume and an outside of the burner body; and
a lower body outer flange extending outward from the lower body outer skirt; and
the upper body portion further includes:
an upper body outer skirt extending outward from an outer perimeter of the upper body end wall; and
an upper body outer flange extending outward from the upper body outer skirt, the upper body outer flange coupled to the lower body outer flange.

8. The appliance of claim 1, wherein the distal end of the sensor contacts the griddle body.

9. The appliance of claim 1, further comprising a plate coupled to the chassis below the burner assembly, the plate defining a plate aperture, wherein the sensor extends away from the chassis, through the plate aperture, and in a direction towards the burner assembly;
wherein the sensor extends along an axis that extends outward from the chassis, through the plate aperture, and through the burner aperture, such that the sensor is coupled to the chassis directly below the burner aperture; and
wherein the axis extend through a center of the burner aperture, such that the sensor extends through the center of the burner aperture.

10. The appliance of claim 9, further comprising:
a mounting bracket coupled to a bottom surface of the burner body and the plate; and
an igniter bracket coupled to the bottom surface of the burner body and configured to couple an igniter to the burner body.

11. The appliance of claim 1, further comprising:
a mounting bracket coupled to a bottom surface of the burner body and the chassis; and
an igniter bracket coupled to the bottom surface of the burner body and configured to couple an igniter to the burner body.

12. A system for preparing a food product, the system comprising:
a griddle body configured to receive the food product thereon;
a burner assembly positioned below the griddle body and spaced away from the griddle body, the burner assembly including a burner body having a burner body first end and a burner body second end, and the burner body defining a burner aperture positioned between the burner body first end and the burner body second end; and
a sensor extending axially through the burner aperture, such that a distal end of the sensor is positioned proximate the griddle body.

13. The system of claim 12, wherein the burner body comprises:
an upper body portion including:
an upper body end wall having an upper body end wall inner surface that at least partially defines the burner aperture;
an upper body inner skirt extending inward from the upper body end wall inner surface of the upper body end wall; and
an upper body inner flange extending inward from the upper body inner skirt; and
a lower body portion including:
a lower body end wall having a lower body end wall inner surface that at least partially defines the burner aperture;
a lower body inner skirt extending inward from the lower body end wall inner surface of the lower body end wall; and
a lower body inner flange extending inward from the lower body inner skirt, the lower body inner flange coupled to the upper body inner flange, wherein a burner body volume is defined between the upper body portion and the lower body portion, and the coupling between the lower body inner flange and the upper body inner flange substantially prevents a fluid from flowing out of the burner body volume through the burner aperture.

14. The system of claim 13, wherein the upper body inner skirt, and the upper body inner flange cooperate to define an upper portion of the burner aperture, such that the upper portion of the burner aperture is frustoconical in shape.

15. The system of claim 13, wherein the lower body inner skirt, and the lower body inner flange cooperate to define a lower portion of the burner aperture, such that the lower portion of the burner aperture is frustoconical in shape.

16. The system of claim 12, further comprising a plate positioned below the burner assembly, the plate defining a plate aperture, wherein the sensor extends through the plate aperture in a direction towards the burner assembly, and the sensor extends along an axis that extends outward from the plate and through the burner aperture such that the plate aperture is directly below the burner aperture.

17. The system of claim 12, wherein the distal end of the sensor contacts the griddle body.

18. A burner assembly for an appliance, the burner assembly comprising:
a burner body having a burner body first end and a burner body second end, the burner body defining an aperture positioned between the burner body first end and the burner body second end, the aperture sized to receive a portion of a sensor therethrough; and
a burner tube coupled to the burner body between the aperture and the burner body first end.

19. The burner assembly of claim 18, wherein the burner body comprises:
an upper body portion including:
an upper body end wall having an upper body end wall inner surface that at least partially defines the aperture;
an upper body inner skirt extending inward from the upper body end wall inner surface of the upper body end wall; and
an upper body inner flange extending inward from the upper body inner skirt; and
a lower body portion including:
a lower body end wall having a lower body end wall inner surface that at least partially defines the aperture;
a lower body inner skirt extending inward from the lower body end wall inner surface of the lower body end wall; and
a lower body inner flange extending inward from the lower body inner skirt, the lower body inner flange coupled to the upper body inner flange, wherein a burner body volume is defined between the upper body portion and the lower body portion, and the coupling between the lower body inner flange and the upper body inner flange substantially prevents a fluid from flowing out of the burner body volume through the aperture;
wherein:
the aperture is a first aperture; and
the lower body portion further includes:
a lower body outer skirt extending outward from an outer perimeter of the lower body end wall, the lower body outer skirt defining a plurality of second apertures positioned around a perimeter of the lower body outer skirt and enabling fluid communication between the burner body volume and an outside of the burner body; and
an lower body outer flange extending outward from the lower body outer skirt.

20. The burner assembly of claim 18, wherein:
the aperture defines an axis that extends through a center of the aperture; and
the sensor extends along the axis.
